(19) United States
(12) Patent Application Publication
(10) Pub. No.: US 2006/0283948 A1
(43) Pub. Date: Dec. 21, 2006

(54) Antenna coil, resonant antenna having antenna coil, and card type wireless device having resonant antenna

(75) Inventor: Hiromichi Naito, Okazaki-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/455,931

(22) Filed: Jun. 20, 2006

(30) Foreign Application Priority Data
Jun. 20, 2005 (JP) 2005-179154

(51) Int. Cl. G06K 7/08; G06K 19/06

(52) U.S. Cl. 235/451; 235/492

(57) ABSTRACT

An antenna coil includes: an air-core type flat coil body having a ring shape; and a coil case having a ring shape corresponding to the ring shape of the coil body. The coil case includes a coil accommodation space for accommodating the coil body. The coil accommodation space is disposed in a circumferential direction of the ring shape of the coil case. The coil body includes a plurality of unit coils, each of which has a same winding direction and a same number of turns. The unit coils are connected in parallel each other.

### CROSS REFERENCE TO RELATED APPLICATION

This application is based on Japanese Patent Application No. 2005-179154 filed on Jun. 20, 2005, the disclosure of which is incorporated herein by reference.

### FIELD OF THE INVENTION

The present invention relates to an antenna coil, a resonant antenna having the antenna coil, and a card type wireless device having the resonant antenna.

### BACKGROUND OF THE INVENTION

In recent years, an electronic key system (also called a smart entry system, etc.) is spread. In this electronic key system, ID authentication is performed by wireless communication between this system and a wireless electronic key (also called a portable device) carried by a user. Further, controls of locking/unlocking of a door lock, engine starting, etc. of an automotive vehicle can be performed by commands from this portable device. In the above wireless electronic key, a demand for constructing this wireless electronic key as the card type wireless device made thin is raised to improve carrying convenience property by storing this wireless electronic key into a purse, etc. with a dramatic spread of an IC card, etc. as the background (3 mm or more and 5 mm or less in thickness).

The above electronic key system adopts a communication system able to execute a control one operation such as the locking/unlocking of the door lock and the engine starting if the user approaches the automobile within a constant distance even when no user performs a special button operation, etc. with respect to the wireless electronic key. Concretely, a request radio wave sent out of the automobile side in one direction is received. ID authentication information, control command information relating to the above locking/unlocking or the engine starting, etc. are superposed on the transmitted radio wave and are sent out to the automobile side. In this case, when the user is distantly located, the wireless electronic key and the automobile do not react on communication. On the other hand, when the user approaches, there are many cases in which near distance type direct communication using a low frequency band (50 kHz or more and 500 kHz or less) is adopted so as to detect the radio wave by detouring the radio wave even when the user holds the wireless electronic key in any portion of the user's body.

The radio wave of the low frequency band has a very long wavelength. Therefore, in an antenna used for this radio wave, a so-called LF (Low Frequency) antenna provided by combining an antenna coil and a capacitor resonantly coupled to this antenna coil in a desirable frequency band is normally adopted. When the LF antenna is assembled into the card type wireless device, it is also necessary to reduce the thickness of this antenna coil in conformity with the thickness of a box body of the card type (e.g., 1 mm or more and 3 mm or less).

The card type wireless device is used by the user of an automobile vehicle with carrying it in his pocket or the like. Although the card type wireless device is a precision electric device, mechanical usage environment of the device is strict. Accordingly, when the device receives mechanical impact or vibration, an antenna wiring may be broken, or a connection portion (in general, a solder portion) of a substrate terminal of the antenna may be broken or cause conduction error. When the antenna in the card type wireless key of the vehicle is broken down, communication function of the wireless key is lost, and fundamental function such as a door-lock release function and/or an engine start function may be damaged. Further, in the card type wireless key, a transmitting/receiving circuit in the key is energized by a battery. The key includes a transponder for generating a radio wave, which is generated with using a request radio wave outputted from the vehicle when the battery runs out of power. However, in a case where the antenna is mutually used for the transmitting/receiving circuit and for the transponder, the transponder may be unavailable when the antenna is broken.

### SUMMARY OF THE INVENTION

In view of the above-described problem, it is an object of the present disclosure to provide an antenna coil, a resonant antenna having the antenna coil and a card type wireless device having the resonant antenna.

According to a first aspect of the present disclosure, an antenna coil includes: an air-core type flat coil body having a ring shape; and a coil case having a ring shape corresponding to the ring shape of the coil body. The coil case includes a coil accommodation space for accommodating the coil body. The coil accommodation space is disposed in a circumferential direction of the ring shape of the coil case. The coil body includes a plurality of unit coils, each of which has a same winding direction and a same number of turns. The unit coils are connected in parallel each other.

In the above antenna coil, even of one of the unit coils is broken, another one of the unit coils functions as a backup coil so that sufficient antenna function is maintained. Further, since multiple unit coils are integrally accommodated in the coil case, the dimensions of the antenna coil are minimized. Further, the antenna coil is easily mounted on a substrate. Furthermore, combined direct current resistance of the coil body is reduced, compared with a conventional antenna. Thus, a Q value of the antenna coil is improved.

According to a second aspect of the present disclosure, a resonant antenna includes: an antenna coil defined in the above first aspect of the present disclosure; and a resonant capacitor connecting in parallel to the antenna coil. The unit coils in the antenna coil provide a capacitance between wirings of the unit coils. The resonant capacitor has a capacitance. The capacitance of the unit coils is larger than the capacitance of the resonant capacitor.

The inductance of the antenna coil and the capacitance of the resonant capacitor are determined such that a resonant point is set to be in a predetermined frequency range. However, if one of the unit coils is broken, the broken unit coil is coupled with the not-broken unit coils through the capacitance between the wirings of the unit coils so that a parasitic series resonant circuit is provided between a capacitance between wirings of the unit coils and the broken unit coil. When the resonant point of the parasitic series resonant circuit is disposed near the designed antenna resonant point, the sensitivity of the antenna may be reduced. Even in this case, in the above resonant antenna, the resonant point of the parasitic series resonant circuit is set to be sufficiently lower frequency side; and therefore, the antenna sensitivity of the resonant antenna is prevented from reducing.

According to a third aspect of the present disclosure, a card type wireless device includes: a communication module substrate having a resonant antenna and a transmitting/receiving circuit; and a card type casing for accommodating the communication module substrate in such a manner that a thickness direction of the card type casing coincides with a thickness direction of the communication module substrate. The resonant antenna includes an antenna coil defined in the first aspect of the present disclosure and a resonant capacitor connecting in parallel to the antenna coil. The transmitting/receiving circuit connects to the resonant antenna. The coil body in the antenna coil has an axis, which coincides with a normal line of the communication module substrate. The coil body is bonded to the communication module substrate with solder.

The above wireless device is thin. Therefore, it is preferable to put the card type wireless device into a wallet or the like. Further, even when a coin in the wallet overlaps a principal surface of the card type wireless device, the antenna coil has sufficient area so that the coin does not interrupt the antenna coil completely. Thus, the card type wireless device has high sensitivity.

### BRIEF DESCRIPTION OF THE DRAWINGS

The above and other objects, features and advantages of the present invention will become more apparent from the following detailed description made with reference to the accompanying drawings. In the drawings:

FIG. 1A is an exploded perspective view showing an antenna coil according to a first embodiment of the present invention, and FIG. 1B is a partially enlarged view showing a part of the antenna coil in FIG. 1A;

FIG. 2A is a front view, FIG. 2B is a bottom view, FIG. 2C is a backside view, and FIG. 2D is a side view showing the antenna coil in FIG. 1A;

FIG. 3A is a cross sectional view showing the antenna coil taken along line IIIA-IIIA in FIG. 2A, and FIG. 3B is a cross sectional view showing the antenna coil taken along line IIIB-IIIB in FIG. 2A;

FIG. 4 is a schematic view showing a wireless key system having a card type wireless device;

FIG. 5 is a partially cutaway perspective view showing the card type wireless device;

FIG. 6A is a perspective view explaining an antenna coil having two unit coils, and FIG. 6B is a cross sectional view showing the antenna coil in FIG. 6A;

FIG. 7 is a circuit diagram showing a resonant antenna having the antenna coil;

FIG. 8 is an exploded perspective view showing an antenna coil according to a second embodiment of the present invention;

FIG. 9A is an exploded perspective view showing an antenna coil according to a third embodiment of the present invention, and FIG. 9B is a cross sectional view showing the antenna coil in FIG. 9A;

FIG. 10A is an exploded perspective view showing an antenna coil according to a fourth embodiment of the present invention, and FIG. 10B is a cross sectional view showing the antenna coil in FIG. 10A;

FIG. 11 is an exploded perspective view showing an antenna coil according to a fifth embodiment of the present invention;

FIG. 12 is a cross sectional view showing an antenna coil according to a modification of the present invention;

FIG. 13 is a schematic view explaining a method for manufacturing a communication module according to an embodiment of the present invention;

FIG. 14A is a schematic view explaining a warpage of a coil case in a reflow process, and FIG. 14B is a schematic view showing soldering failure of the coil case;

FIG. 15 is an exploded perspective view showing an antenna coil according to a sixth embodiment of the present invention;

FIG. 16 is an exploded perspective view showing an antenna coil according to a seventh embodiment of the present invention;

FIG. 17 is an exploded perspective view showing an antenna coil according to an eighth embodiment of the present invention; and

FIG. 18 is a perspective view explaining an antenna coil having two unit coils, which are stacked each other.

### DETAILED DESCRIPTION OF THE PREFERRED EMBODIMENTS

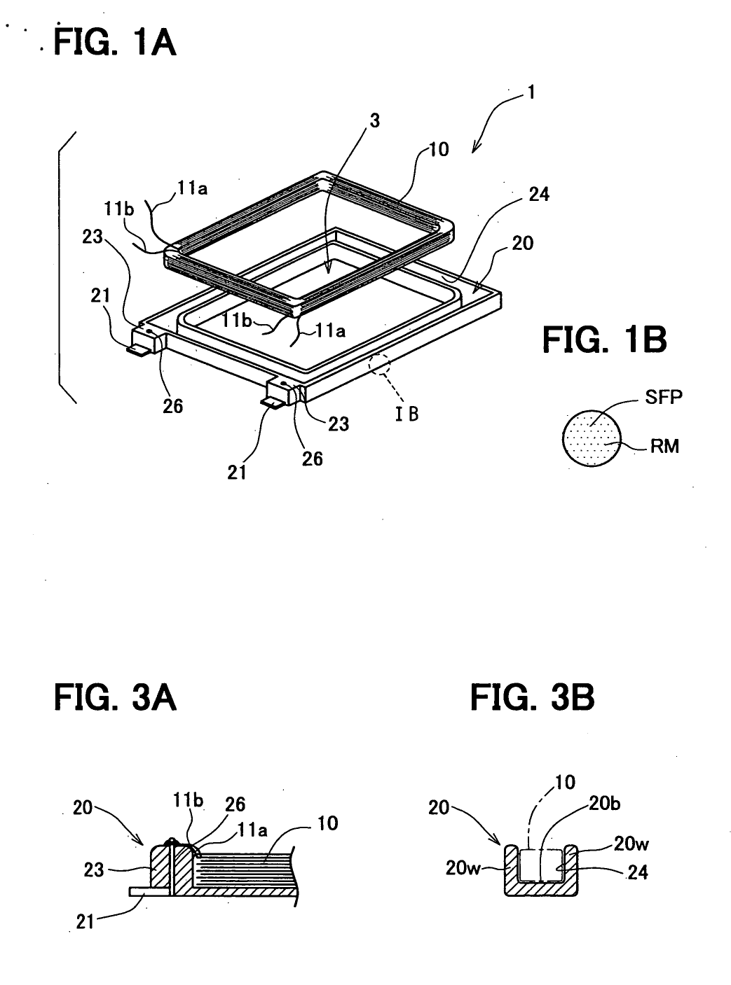

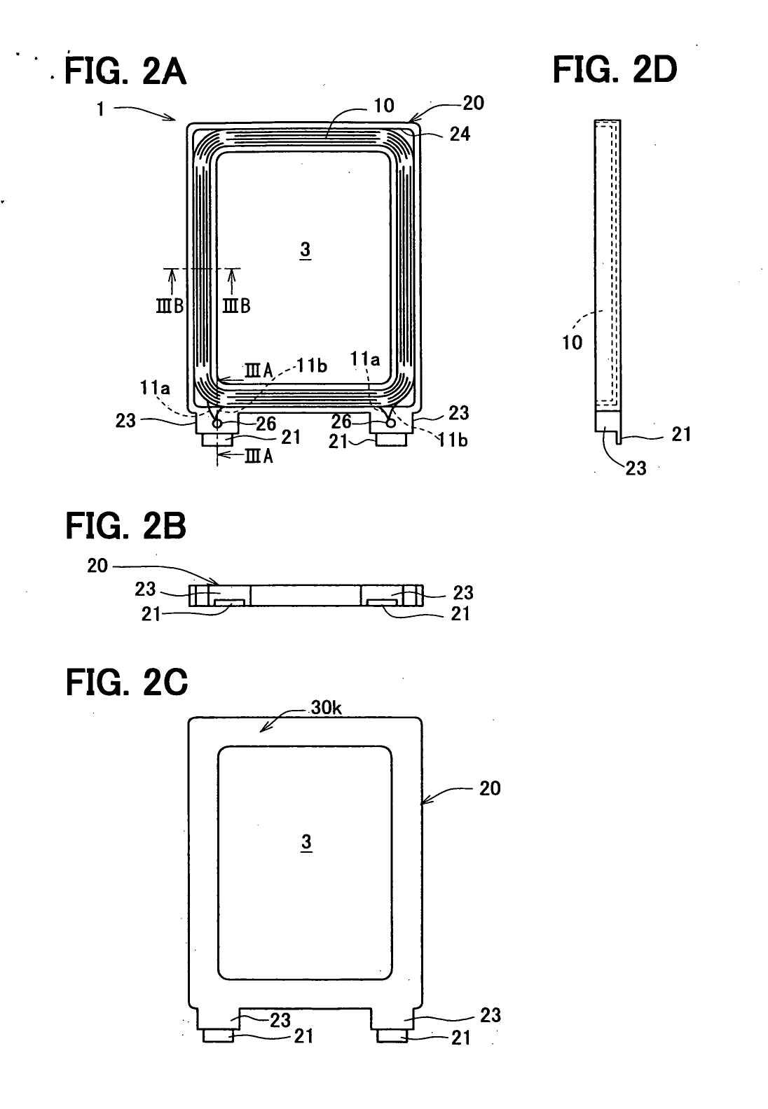

FIGS. 1A and 2B show an exploded perspective view of an antenna coil 1 as one example of the invention. FIGS. 2A to 2D are four face views (a plan view, a front view, a side view and a bottom view) of the antenna coil 1. The antenna coil 1 has a coil main body 10 of an air-core type of a flat shape, and a coil case 20. The coil case 20 is formed in a ring-shaped mode corresponding to the coil main body 10, and a coil storing portion 24 for storing this coil main body 10 is formed in the circumferential direction. As shown in FIG. 7, the coil main body 10 includes multiple unit coils 10a, 10b, which are connected in parallel. Each unit coil 10a, 10b has the same winding direction and the same number of turns. Although the coil main body 10 includes two unit coils 10a, 10b, the body 10 may have three or more unit coils.

The thickness of the coil main body 10 in its axial direction is set to be smaller than the radius of a circle of the same area as an area (planar outer shape area) surrounded by a self outer shape line at a projecting time to a projecting face perpendicular to this axis. “The coil main body 10 is formed in the flat shape” is “the thickness of the coil main body 10 in its axial direction is set so as to be smaller than the radius of the circle of the same area as the area (planar outer shape area) surrounded by the self outer shape line at the projecting time to the projecting face perpendicular to this axis.” A coil side terminal portion 21 for soldering and mounting the coil main body 10 onto a substrate is arranged in the coil case 20.

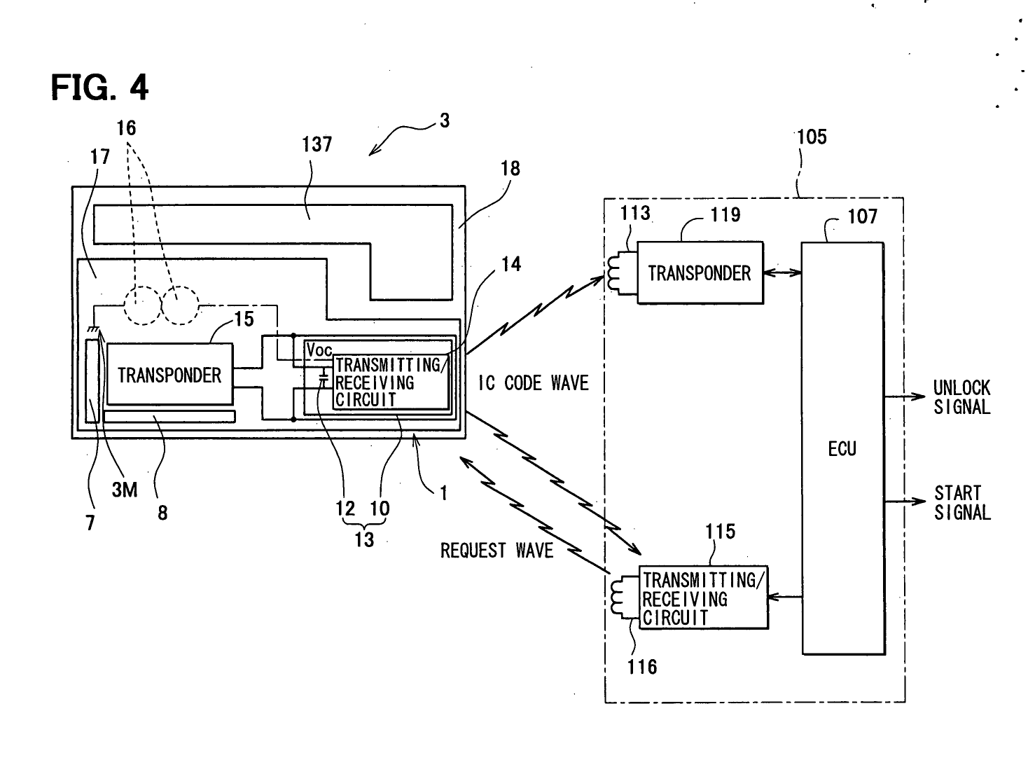

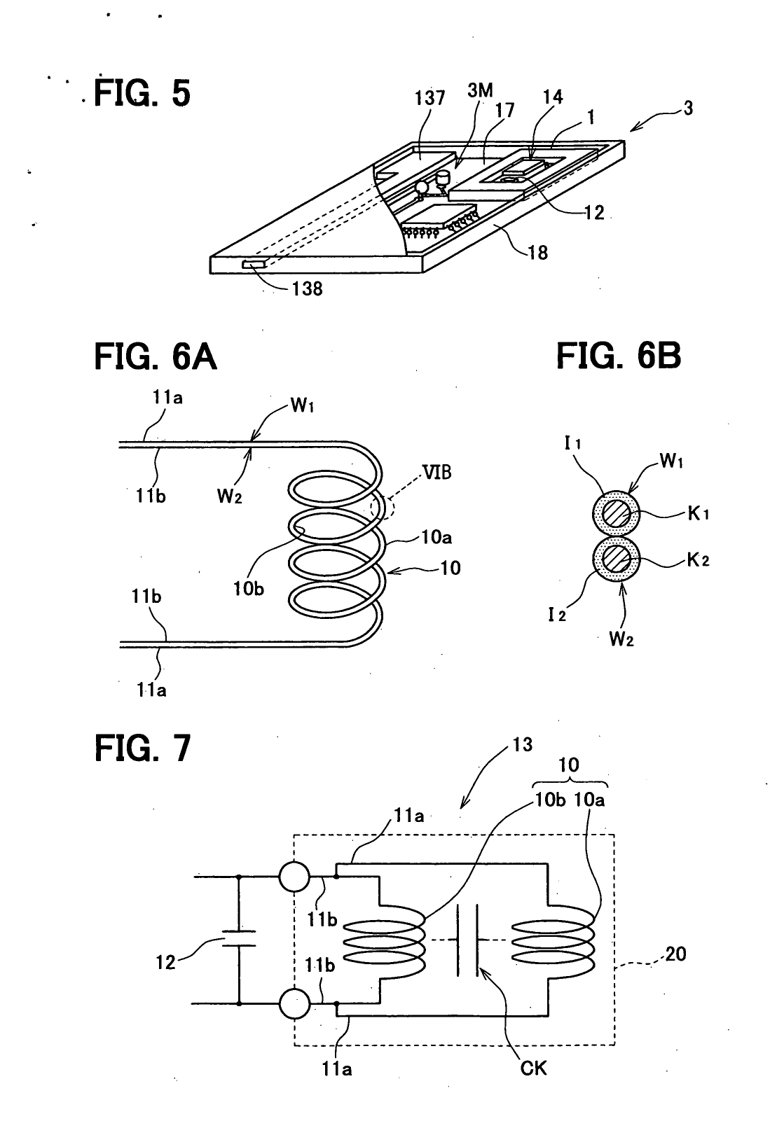

As shown in FIG. 4, the above antenna coil 1 is soldered and mounted to the substrate 17 together with a signal transmitting-receiving circuit 14 connected to this antenna coil 1 in a position relation in which the axis of the coil main body 10 is conformed to the normal direction of the substrate 17. Thus, a communication substrate module 3M is constructed. In this communication substrate module 3M, the antenna coil 1 constitutes an LF antenna, i.e., a resonant antenna 13, together with a capacitor 12 resonantly coupled to this antenna coil 1 in parallel. As shown in FIG. 5, this capacitor 12 and the signal transmitting-receiving circuit (IC) 14 are mounted to a substrate area on the inside of an air gap of the antenna coil 1. Further, a transponder circuit 15 is connected to the above resonant antenna 13 in parallel with the signal transmitting-receiving circuit 14. As shown in FIG. 4, the transponder circuit (IC) 15 is mounted to a substrate area outside the antenna coil 1.

The coil axis of the antenna coil 1 is conformed to the normal direction of the substrate face so that directivity with respect to transmission and reception of a radio wave in this direction is raised. Separate coils 7, 8 having axes conformed to two independent directions within the substrate face may be also mounted to the substrate 17 (these coils 7, 8 are drawn by omitting connection wiring in FIG. 4, but each of these coils 7, 8 is connected to the antenna coil 1 in parallel).

As shown in FIG. 5, the above communication substrate module 3M is stored to a box body 18 of a card shape in a shape for conforming the thickness direction to the substrate 17 so that a card type wireless device 3 is constructed. As shown in FIG. 4, the card type wireless device 3 is a wireless key for an automotive vehicle for transmitting a communication signal to the vehicle through a radio wave communication. The communication signal includes an ID authentication signal and a control signal for controlling a door lock/unlock function and an engine start function. The resonant antenna 13 is mutually used for the transmitting-receiving circuit 14 and for the transponder circuit 15. The transmitting-receiving circuit 14 is energized by a battery in order to perform the radio wave communication. The transponder circuit 15 is energized by a request electromagnetic wave outputted from the vehicle so that the transponder circuit generates an electromagnetic wave corresponding to the communication signal for outputting to the vehicle. This wireless key for the vehicle is a card type key having a small thickness; and therefore, it is preferable to put it into a wallet or the like.

As shown in FIG. 4, a dry battery 16 as a driving power source of the signal transmitting-receiving circuit 14 is also stored to the box body 18. Further, a mechanical type key 137 for emergency is also stored to the box body 18, and can be detached from a slot 138 formed on the side face of the box body 18 as shown in FIG. 5.

As shown in FIG. 4, a body system ECU 107 of the automobile 105 periodically sends out a request radio wave for detecting approaching of a user carrying the card type wireless device 3 from an antenna 116 through a signal transmitting-receiving circuit 115 connected to this body system ECU 107. When the user approaches the automobile 105 within a constant distance, the resonant antenna 13 built in the card type wireless device 3 receives this request radio wave. The signal transmitting-receiving circuit 14 receives this request radio wave and sends out an ID code for authentication by a radio wave of a prescribed frequency band. The automobile side body system ECU 107 receiving this ID code radio wave through the antenna 116 and the signal transmitting-receiving circuit 115 authenticates whether the sent ID is a correct ID. When the authentication is received, the body system ECU 107 outputs an unlock allowance signal for releasing the door lock and a starting allowance signal of an engine.

On the other hand, when the dry battery 16 of the card type wireless device 3 is consumed and no signal transmitting-receiving circuit 14 is operated, the request radio wave received by the resonant antenna 13 is sent to the transponder circuit 15. In the transponder circuit 15, electromotive force excited in the antenna coil 10 by the request radio wave is set to electric power, and the transponder circuit 15 sends out an ID code radio wave from the resonant antenna 13. In the automobile 105, this ID code radio wave is received by the antenna 113 and the transponder circuit 119, and processings after the authentication can be similarly performed. Namely, the transponder circuit of the card type wireless device 3 functions as a backup circuit at a battery running-out time.

When the above card type wireless device 3 is carried together with a purse, etc., there is a fear that a conductor of a comparatively large area such as a coin, etc. covers the antenna coil 1, and the sensitivity of the antenna and Q (frequency selecting degree) are reduced. However, even when a situation for overlapping the coin with the main surface of the card type wireless device 3 is supposed, it is possible to reduce the probability that the antenna coil 1 is perfectly covered with the coin, etc. as mentioned above if the antenna coil 1 is mounted to the substrate as a flat air-core type coil of a constant area or more as shown in FIG. 4. In its turn, the card type wireless device 3 of high sensitivity can be realized.

The planar outer shape of the card type wireless device 3 can be set to have short sides of 40 mm or more and 60 mm or less (e.g., 50 mm), and long sides of 75 mm or more and 95 mm or less (e.g., 85 mm), and a thickness of 2 mm or more and 5 mm or less (e.g., 4 mm) (e.g., this planar outer shape has about the same size as the size of a credit card). In the assembled antenna coil, the area of a planar outer shape area can be set to 8 cm² or more and 15 cm² or less (e.g., 12 cm²). The width of the coil main body 10 at a projecting time to a projecting face perpendicular to the axis can be set to 1 mm or more and 4 mm or less (e.g., 3 mm). Further, the thickness of the coil case 20 in its axial direction can be set to 1 mm or more and 3 mm or less (e.g., 1.6 mm). As described later, in this embodiment mode, the antenna coil 1 is constructed so as to have a planar mode of a rectangular shape, and have a short side of 25 mm or more and 35 mm or less (e.g., 30 mm), and a long side of 35 mm or more and 45 mm or less (e.g., 40 mm).

The coil main body 10 includes two unit coils 10a, 10b, each of which has the same winding direction and the same number of turns and are connected in parallel each other. Even if one of unit coils 10a, 10b, for example, the unit coil 10a is broken such as breaking of wire and/or connection failure between terminals, the residual unit coil, i.e., the unit coil 10b functions as a backup coil. Thus, the antenna 13 can be operated normally. Further, since the unit coils 10a, 10b are connected in parallel each other, total cross sectional area of wiring in the main body 10 is twice larger than that of a conventional antenna having one coil. Thus, combined direct current resistance of the main body 10 is reduced, compared with the conventional antenna. Thus, a Q value (i.e., a degree of selectivity of frequencies) is improved. Further, in the wireless key 3 having the antenna coil 1, the transmitting-receiving circuit 14 is operated with the battery. Further, even if the battery runs out of power, the transponder circuit 15 generates the electromagnetic wave by using the request electromagnetic wave outputted from the vehicle as a power source. Furthermore, even if one of the unit coils 10a, 10b in the antenna coil 1 is broken, the antenna coil can function as an antenna. Thus, reliability and fail safe function of the antenna coil 1 are improved.

As shown in FIG. 7, in the resonant antenna 13, a capacitance between wirings of the unit coils 10a, 10b is larger than that of the capacitor 12 for resonance, i.e., a resonant capacitor. Specifically, as shown in FIGS. 6A and 6B, multiple wirings of the unit coils 10a, 10b are covered with insulation films, respectively. The wirings in the unit coils 10a, 10b are bundled, and the bundled wirings are winded together along with a predetermined winding path having a ring shape, i.e., a helical shape. For example, each unit coil 10a, 10b includes a winding W1, W2 having a core wiring K1, K2. A diameter of each core wiring K1, K2 is in a range between 50 μm and 70 μm. The core wiring K1, K2 is a resin coating wiring having a resin coat with thickness I1, I2 in a range between 2 μm and 5 μm. The number of turns of each unit coil 10a, 10b is in a range between 200 turns and 300 turns. The inherent inductance of the coil main body 10 is in a range between 4 mH and 6 mH. The capacitance between the unit coils 10a, 10b is in a range between 2000 pF and 6000 pF. When the capacitance of the resonant capacitor 12 is set to be in a range between 300 pF and 400 pF, the antenna resonance point of the resonant antenna 13 is controlled to be in a range between 100 kHz and 150 kHz.

Here, if one of the unit coils has a certain failure, a parasitic series resonant circuit is provided by one of the unit coil having the certain failure such as a breaking of wire and capacitance between the unit coils 10a, 10b. The parasitic series resonant circuit has a resonant point, which is lower than that of the parallel resonant circuit provided by the coil main body 10 and the resonant capacitor 12. The resonant point of the parallel resonant circuit is an antenna resonant point. Accordingly, the resonant point of the parasitic series resonant circuit is shifted in a lower frequency side, compared with the parallel resonant circuit. Thus, reduction of antenna sensitivity is prevented. Further, since the coil main body 10 is formed by mutually winding the unit coils 10a, 10b having the above dimensions, the capacitance between the unit coils 10a, 10b is equal to or more than five times as large as the capacitance of the resonant capacitor 12. Specifically, the capacitance between the unit coils 10a, 10b is in a range between six times and 30 times as large as the capacitance of the resonant capacitor 12. Accordingly, the resonant point of the parasitic series resonant circuit is sufficiently lower than the antenna resonant point of the parallel resonant circuit. Thus, even if one of the unit coils 10a, 10b is broken, deviation, i.e., shift of the antenna resonant point is small.

As shown in FIG. 18, the unit coils 10a, 10b may be winded individually, and after that, the winded unit coils 10a, 10b are accommodated in a coil case such that the unit coils 10a, 10b are stacked each other. In this case, the capacitance Ck between the unit coils 10a, 10b is smaller than that of the unit coils 10a, 10b shown in FIGS. 6A and 6B. When the capacitance Ck between the unit coils 10a, 10b is less than five times as large as the capacitance of the resonant capacitor 12, the antenna resonant point may shift about 10 percents when one of the unit coils 10a, 10b is broken.

For example, in FIGS. 6A and 6B, the core wiring K1, K2 of the winding W1, W2 in each unit coil 10a, 10b has a diameter of 60 μm, the thickness of a poly-urethane resin coating I1, I2 is 3 μm, and the number of turns is 250 turns. In this case, the inherent inductance of the coil main body 10 is 5 mH, and the capacitance between the unit coils 10a, 10b is 4000 pF. When the capacitance of the resonant capacitor 12 is 350 pF, the antenna resonant point of the resonant antenna 13 is 134 kHz. When one of the unit coils 10a, 10b is broken, the antenna resonance point is not changed substantially, although the Q value is reduced by 30 percents, in a case where the coil main body 10 is composed of the unit coils 10a; 10b shown in FIGS. 6A and 6B. On the other hand, in a case where the coil main body 10 is composed of the unit coils 10a, 10b shown in FIG. 18, the antenna resonance point is changed by 10 percents when one of the unit coils 10a, 10b is broken.

As shown in FIG. 13, the coil side terminal portion 21 is set to a terminal pad 21 for performing face-mounting onto the substrate as a mounting destination on the bottom face side of the coil case 20. A solder paste pattern formed by printing, etc. is arranged as the above solder material 135 between the terminal pad 21 and the substrate side pad 134. As shown in FIGS. 2A to 2D, the outer shape lines of the coil main body 10 and the coil case 20 are rectangular shapes, and the terminal pad 21 is arranged in a long side direction end portion of the coil case 20.

The terminal pad 21 can be also arranged on the bottom face of the coil case 20. However, in this case, a pair of lead portions 11a, 11b of each unit coil 10a, 10b of the coil main body 10 must be connected to a position corresponding to the above terminal pads 21 of the bottom face of the coil storing portion 24 of a narrow width, and an assembly work of the coil main body 10 into the case becomes very complicated. Therefore, as shown in FIGS. 3A and 3B, in this embodiment mode, a pin burying portion 23 burying a connecting pin 26 thereinto in the axial direction is projected and formed on the outer circumferential face of the coil case 20. The connecting pin 26 provides an antenna terminal. The lead portions 11a, 11b of the coil main body 10 are constructed so as to be connected to the upper end of the connecting pins 26 projected onto the top face of this pin burying portion 23. Thus, the assembly work becomes greatly easy. The terminal pad 21 is arranged on the bottom face of the pin burying portion 23, and a lower end portion of the connecting pin 26 is conducted to the terminal pad 21.

In FIG. 1A, the coil case 20 includes a groove having an opening on its top surface in an axial direction of the coil case 20 so that the coil storing portion 24. On the other hand, in FIG. 17, the coil case 120 includes the coil storing portion 24, which is disposed along with a circumferential side surface of the case 120.

As shown in FIGS. 2A to 2D, the coil case 20 has only one pair of the connecting pins 26, i.e., the antenna terminals. Each lead portion 11a of the unit coils 10a, 10b in the coil main body 10 has the same polarity, and the lead portions 11a of the unit coils 10a, 10b are mutually connected to the connection pin 26 (i.e., one of the antenna terminals). Similarly, each lead portion 11b of the unit coils 10a, 10b in the coil main body 10 has the same polarity opposite to the lead portion 11a, and the lead portions 11b of the unit coils 10a, 10b are mutually connected to the other connection pin 26 (i.e., the other one of the antenna terminals). In this case, the number of terminals in the coil case 20 can be reduced, so that the construction of the antenna coil 1 is simplified. Further, when the antenna coil 1 is mounted on a substrate, the number of the connection terminals in the substrate for connecting to the antenna coil 1 is also reduced. In the coil case 120 in FIG. 17, the lead portions 11a, 11b are bonded to a pair of the connection pins 121 with solder, the connection pins 121 which are embedded in a common pin embedding portion 123, respectively.

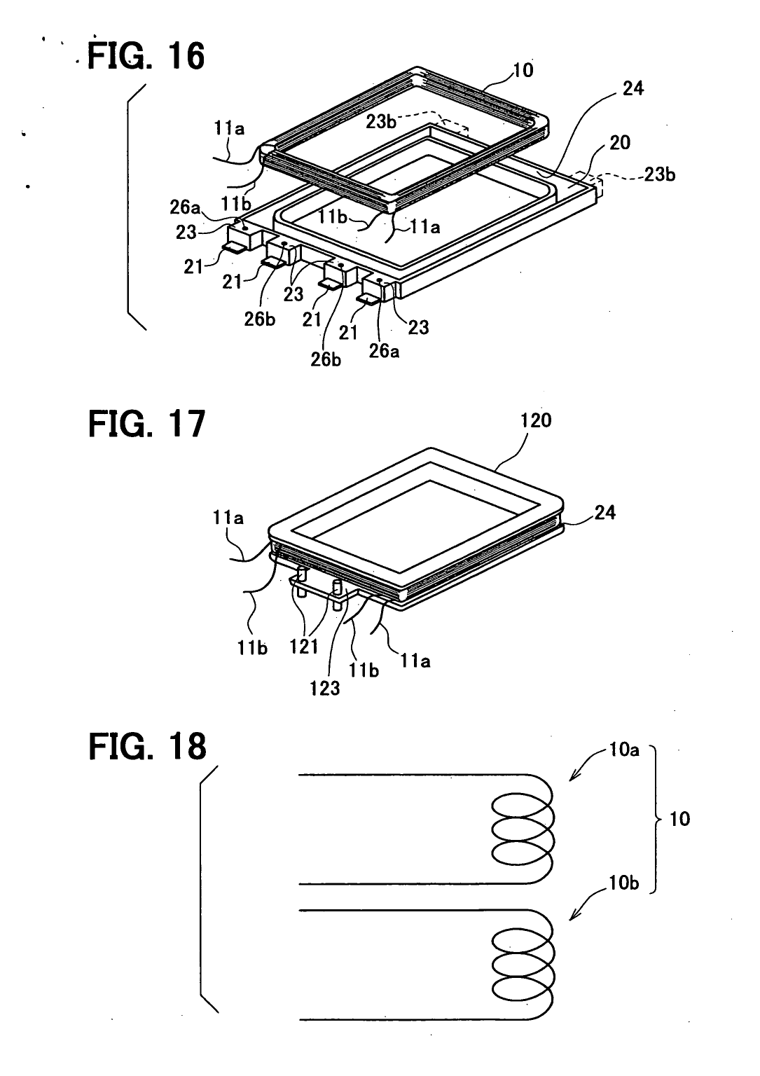

As shown in FIG. 16, the coil case 20 may include multiple pairs of the connection pins 26a, 26b, which correspond to the unit coils 10a, 10b. In this case, the lead portions 11a, 11b in each unit coil 10a, 10b are connected to the connection pins 26a, 26b, respectively, the connection pins 26a, 26b corresponding to the lead portions 11a, 11b. In this case, although the number of the antenna terminals in the coil case 20 is increased, multiple unit coils 10a, 10b are not mutually connected to one antenna terminal. Therefore, even if conducting failure and/or soldering failure is occurred at the antenna terminal, only one unit coil 10a, 10b is broken. Accordingly, fail safe function of the antenna coil 1 is secured. All connection pins 26a, 26b are intensively formed on only one of long sides of the coil case 20 having a rectangular ring shape. Alternatively, all connection pins 26a, 26b may be formed on only one of short sides of the coil case 20. Alternatively, one pair 23b of the pin burying portions 23 may be formed on the other one of long sides of the coil case 20 so that one pair of the connection pins 26a, 26b corresponding to two unit coils 10a, 10b is formed on the one pair 23b disposed on the other one of the long sides of the coil case 20.

As shown in FIG. 13, in the communication substrate module 3M used in the above card type wireless device 3, a coil side terminal portion 21 of the antenna coil 1 is positioned in a substrate side terminal portion (substrate side pad) 134 together with a soldering material 135 for connection. In its state, the substrate 17 is inserted into a reflow furnace 150 together with the antenna coil 1 positioned and placed on this substrate 17, and is heated. Thus, the soldering material 135 is melted and the coil side terminal portion 21 is soldered and connected to the substrate side terminal portion 134 so that the communication substrate module 3M is manufactured. In this embodiment, the coil case 20 is formed by a resin injection molding method.

In the material of resin constituting the coil case 20, it is desirable to adopt a material able to be injection-molded and not easily softened and deformed even when a thermal hysteresis at the reflow time is applied. As a particularly preferable material from this viewpoint, polyphenylene sulfide (PPS: 282° C. in melting point, about 240° C. in upper limit temperature able to be continuously used, and 260° C. or more in thermal deformation temperature) is adopted in this embodiment mode. However, instead of this material, thermoplastic polyimide (melting point: 388° C.) can be also adopted.

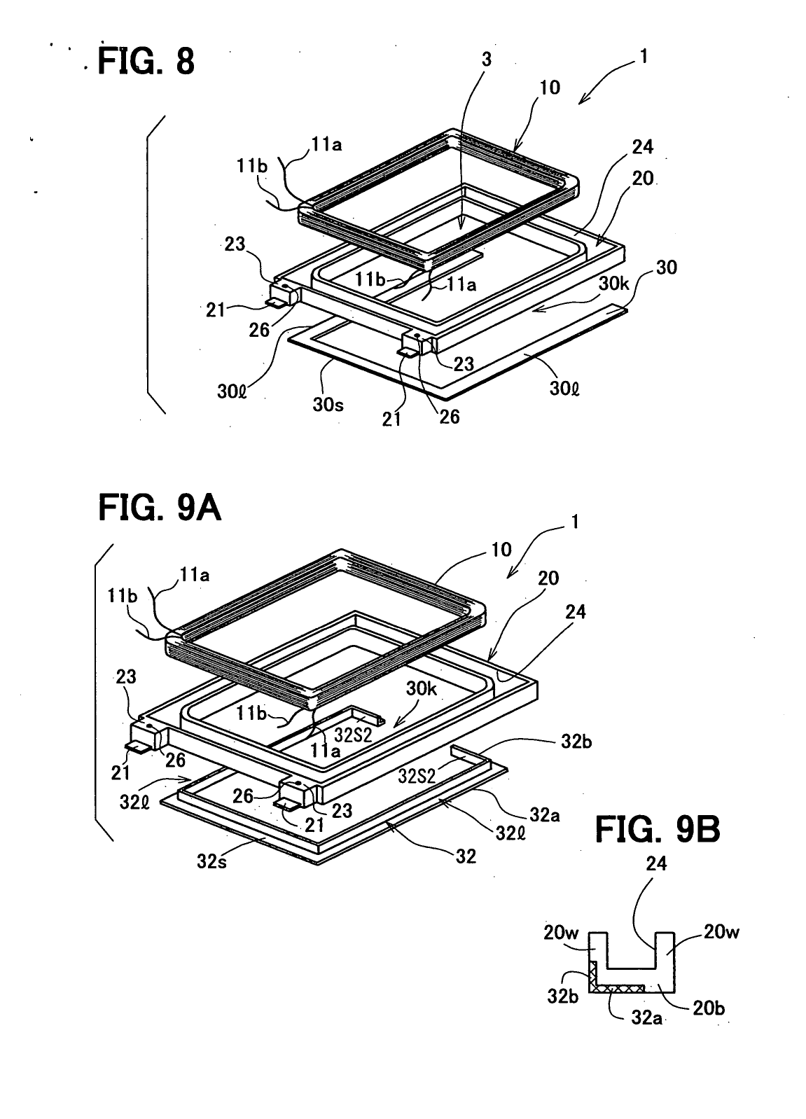

A modified example of the antenna coil 1 of the invention will next be explained (portions common to FIGS. 1A and 2A to 2D are designated by the same reference numerals and their explanations are omitted). In FIG. 8, a reinforcing frame 30 is integrally formed along with a circumferential direction of the coil case 20 made of resin. The reinforcing frame 30 is made of a material having a Young's modulus higher than the resin of the coil case 20. Thus, warpage of the coil case 20 is prevented when a solder reflow step is performed.

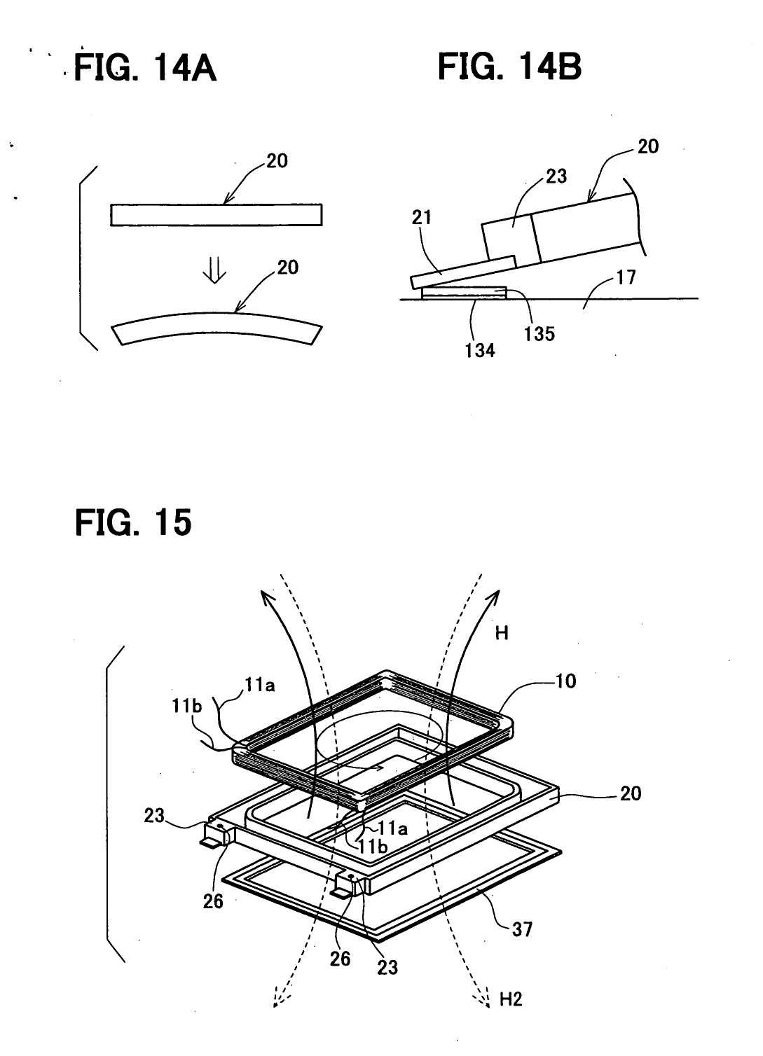

The reinforcing frame 30 is buried in the bottom portion 20b of the coil case 20 for forming the coil storing portion 24 of this groove shape. Concretely, the reinforcing frame 30 is buried to the bottom portion 20b of the coil case 20 by insert molding in a mode in which the outer face of the reinforcing frame 30 and the outer face of the bottom portion 20b become the same face. As shown in FIGS. 14A and 14B, in an antenna case 23 on the substrate 17, heat transfer onto the substrate 17 side is easily advanced on the lower face side when the solder reflow step is performed. On the other hand, a large amount of radiant heat from a furnace heat source is easily received on the upper face side. Accordingly, a rise in temperature of the upper face side is easily advanced so that a temperature gradient of the thickness direction is easily caused between the upper face side and the lower face side facing the substrate 17. Thus, in the coil case 20 manufactured by resin and having a low rigidity, expansion displacement of the in-plane direction on the upper face side becomes greater than that on the lower face side so that a warp is easily caused in an upwardly convex mode. As its result, the coil side terminal portion 21 is floated from the substrate side pad (substrate side terminal portion) 134 by this warp so that a soldering defect is easily caused. However, when the reinforcing frame 30 is formed in the coil case 20, the rigidity of the coil case 20 is increased so that failure regarding the warpage is sufficiently reduced.

The reinforcing frame 30 is set to a metallic frame (hereinafter also called the metallic frame 30). The metallic material is high in Young's modulus and is excellent in processing property, and it is easy to cope with a frame shape corresponding to the coil case 20 of an air-core type by punching processing, etc. Further, the frame sectional shapes of an L-shape and a C-shape can be also easily obtained by press working. The metallic frame is a conductor. As shown by quoting FIG. 15, when the metallic frame is formed in a continuous ring shape mode (reference numeral 37) along the coil case 20, an electric current path turned around the axis of the coil main body 10 is formed. Accordingly, the disadvantage that the metallic frame is inductively coupled to the coil main body 10 and the apparent inductance of the entire antenna coil is reduced, is caused. Namely, when a radio wave magnetic field H extending through the coil main body 10 is changed, an induced electric current is flowed to the metallic frame 30. The radio wave magnetic field relating to the antenna signal transmission and reception is canceled by its reverse magnetic field H2 so that the apparent inductance is reduced. In particular, in the case of the resonant antenna 13 shown in FIG. 4, the capacitor 12 adjusted in capacity so as to cause a resonance point at a desirable frequency with respect to the inductance of its coil main body 10 is connected to the antenna coil 1 in parallel. The Q-value of the antenna is determined by the characteristics of its LC parallel resonating circuit. However, when the metallic frame is formed in a mode as shown by reference numeral 37 of FIG. 15, the apparent inductance of the antenna coil is reduced by its induction coupling. The resonance point of the above LC parallel resonating circuit is shifted from the desirable frequency so that the Q-value and the antenna gain are greatly reduced. In this case, as shown in FIG. 8, when an insulating portion 30k for partially dividing the electric current path turned around the axis of the coil main body 10 is arranged in an intermediate position in the circumferential direction of the metallic frame 30, the above disadvantages can be very effectively dissolved.

In the constructional material of the metallic frame 30, aluminum or an aluminum alloy is comparatively excellent in strength and corrosive property and is preferable in processing property and can be therefore preferably adopted in the invention. On the other hand, the constructional material of the metallic frame 30 can be also set to an iron system material. In this case, a non-magnetic material such as austenite system stainless steel can be also used (aluminum or the aluminum alloy is also non-magnetic), but an iron system soft magnetic material can be also adopted. The soft magnetic material is a ferromagnetic material and is high in magnetic permeability and a radio wave magnetic field relating to the antenna signal transmission and reception can be concentrated onto the metallic frame 30. Accordingly, it is possible to contribute to the improvements of sensitivity and gain of the antenna. As the iron system soft magnetic material, it is possible to adopt a silicon steel plate, general carbon steel, an Fe—Ni alloy (e.g., permalloy, etc.) or ferrite system stainless steel, etc. in addition to electromagnetic soft iron (it can be also said that the electromagnetic soft iron and the ferrite system stainless steel are advantageous from the viewpoint of processing property).

As shown in FIG. 8, in the above metallic frame 30 arranged in a shape along the ring shape path set in the circumferential direction of the coil case 20, the above insulating portion 30k is set to a notch portion (hereinafter also called a notch portion 30k) in which the metallic frame 30 is notched at a partial interval of the arranging path. The insulating portion 30k for partially dividing an electric current conducting path of the circumferential direction can be simply formed by setting the metallic frame 30 to an ended shape instead of the continuous ring shape and spacing its end portions by a constant length and setting a notch mode.

The outer shape lines of the coil main body 10 and the coil case 20 are rectangular shapes, and the metallic frame 30 is arranged in a C-shape including one short side portion 30s corresponding to the outer shape line of the rectangular shape, and two long side portions 30l connected to both ends of this short side portion 30s. The above notch portion 30k is formed by using the entire interval on the remaining short side of the outer shape line of the rectangular shape. If the C-shaped portion provided by integrating the two long side portions 30l and the one short side portion 30s is formed in the metallic frame 30, rigidity with respect to twisting deformation of a frame face is raised in comparison with a case partially divided and formed on each side of the rectangular shape, and a warp causing the twisting deformation can be effectively restrained.

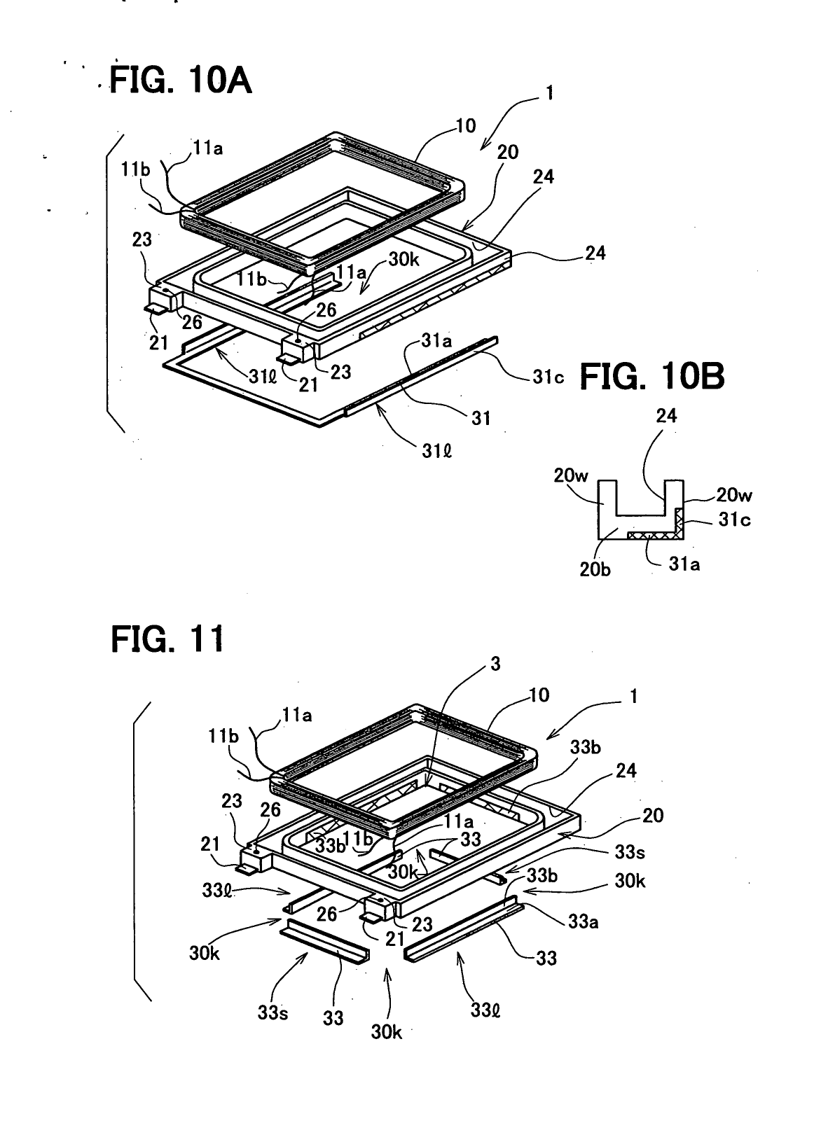

In FIGS. 9A to 10B, metallic frames 32, 31 have main body portions 32a, 31a arranged in a C-shape on the bottom face of the coil case 20. In at least two long side portions 32l, 31l, reinforcing rib portions 32b, 31c exposed to the outer circumferential face or the inner circumferential face of the coil case 20 are integrated in the main body portions 32a, 31a in a shape forming an L-shaped section together with these main body portions 32a, 31a. Since the sectional shape of the metallic frame 30 is set to the L-shape correspondingly to the long side portion 30l of the coil case 20 easily amplified in warp displacement, its bending rigidity is raised and the warp deformation of the long side direction can be effectively restrained.

In FIGS. 9A and 9B, the reinforcing rib portion 32b is formed in a continuous C-shape laid across one short side portion 32s and two long side portions 32l connected to both ends of this short side portion 32s. When the reinforcing rib portion 32b is formed in this way, it is possible to further raise rigidity with respect to twisting deformation of the frame face made by the C-shaped portion. Each of the main body portion 32a and the reinforcing rib portion 32b is formed in a shape laid across a partial interval 32s2 constituting both end portions of the remaining short side portions from two long side portions 30l so that a reinforcing effect is further raised. The metallic frame 32 is integrated with the coil case 20 by insert molding such that the main body portion 32a has the same face as the outer face of the bottom portion 20b of the coil case 20 and the reinforcing rib portion 32b has the same face as the outer face of a side wall portion 20w. Here, the reinforcing rib portion 32b is arranged on the inner circumferential face side of the coil case 20b, but may be also arranged on the outer circumferential face side.

On the other hand, in the construction of FIGS. 10A and 10B, the reinforcing rib portion 31c is arranged in only two long side portions 30l of the main body portion 31a. This mode has an advantage in that manufacture using press working, etc. is easy. Here, the reinforcing rib portion 31c is arranged on the outer circumferential face side of the coil case 20b (may be also reversely arranged).

In the construction of FIG. 11, a metallic frame 33 is constructed by forming notch portions 30k in four corner portions of the outer shape line of a rectangular shape, and dividing the metallic frame 33 into four portions constructed by two long side portions 33l and two short side portions 33s by this notch portion 30k. In accordance with this construction, there is an advantage able to reinforce all the four sides of the coil case 20 of the rectangular shape. In this case, the warp preventing effect can be further notably achieved by constructing each portion so as to have an L-shaped section which has a main body portion 33a arranged on the bottom face of the coil case 20, and also has a reinforcing rib portion 33b integrated with this main body portion 33a in a shape exposed to the inner circumferential face (or the outer circumferential face) of the coil case 20.

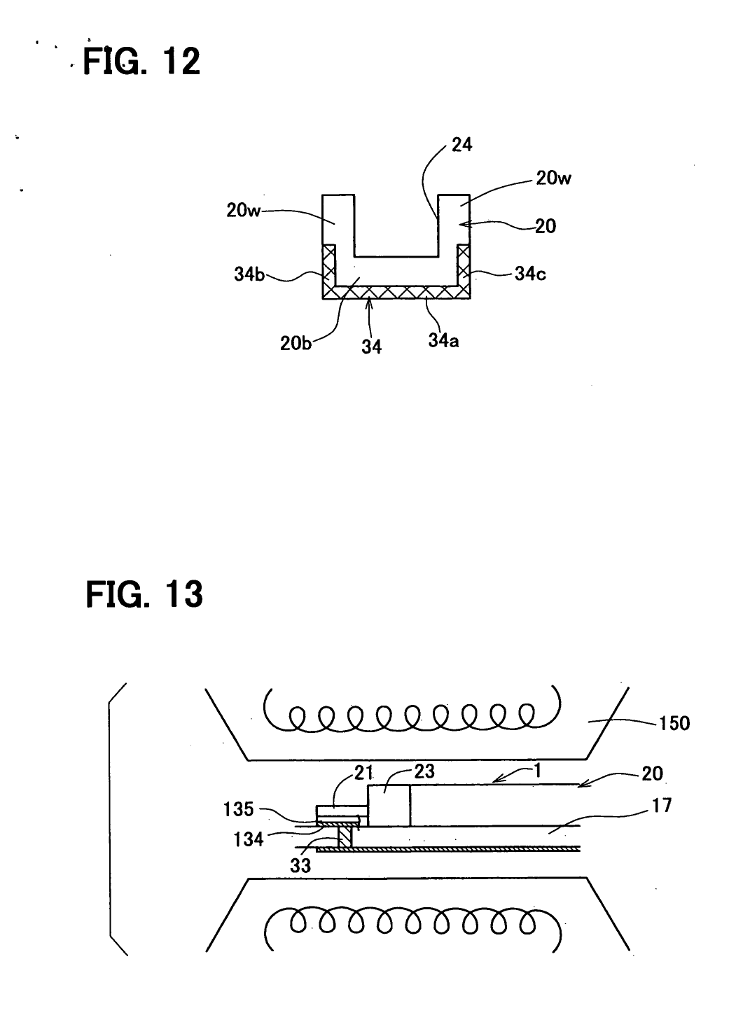

In the construction of each of FIGS. 9A to 11, the metallic frame can be constructed so as to have the sectional shape of a C-shaped mode formed by integrating the main body portion 34a arranged in the bottom portion 20b of the coil case 20, and a pair of reinforcing rib portions 34b, 34c respectively arranged in two side wall portions 20w as shown in FIG. 12.

Next, the material of the reinforcing frame is not particularly limited if the Young's modulus of this material is higher than that of resin constituting the coil case 20. For example, it is also possible to adopt an insulating inorganic material such as glass, ceramic of alumina, etc., sintering soft ferrite, etc. Further, the material of the reinforcing frame can be also constructed by a resin composite material strengthened by a filler of glass, ceramic, etc. In this case, since the reinforcing frame 37 becomes an insulator, there is no fear of a reduction in apparent inductance by inductive coupling to the coil main body 10 even when the reinforcing frame 37 is constructed in the mode of a continuous ring shape in the circumferential direction in the coil case 20 as shown in FIG. 15. Accordingly, it is excellent in the reinforcing effect of the coil case 20. In this case, when the reinforcing frame 37 is constructed by sintering soft ferrite and resin ferrite formed by resin-coupling soft ferrite powder, the radio wave magnetic field relating to the antenna signal transmission and reception can be concentrated onto the metallic frame 37. Accordingly, it is possible to contribute to the improvements of sensitivity and gain of the antenna.

Alternatively, in FIGS. 1A, 8 to 11, and 15 to 17, the coil case 20 may be made of resin ferrite (i.e., resin molded soft magnetic material), which is formed such that soft magnetic material powder such as soft ferrite powder (i.e., SFP) is bonded with resin (i.e., resin mold, RM) such as PPS resin. In this case, the soft ferrite powder and the PPS resin are mixed into a compound, and then, the compound is injected and molded, so that the coil case 20 is formed.

The present disclosure has the following aspects.

According to a first aspect of the present disclosure, an antenna coil includes: an air-core type flat coil body having a ring shape; and a coil case having a ring shape corresponding to the ring shape of the coil body. The coil case includes a coil accommodation space for accommodating the coil body. The coil accommodation space is disposed in a circumferential direction of the ring shape of the coil case. The coil body includes a plurality of unit coils, each of which has a same winding direction and a same number of turns. The unit coils are connected in parallel each other.

In the above antenna coil, even of one of the unit coils is broken, another one of the unit coils functions as a backup coil so that sufficient antenna function is maintained. Further, since multiple unit coils are integrally accommodated in the coil case, the dimensions of the antenna coil are minimized. Further, the antenna coil is easily mounted on a substrate. Furthermore, combined direct current resistance of the coil body is reduced, compared with a conventional antenna. Thus, a Q value of the antenna coil is improved.

Alternatively, the coil body may have a thickness in an axial direction of the coil body, and the thickness of the coil body may be smaller than a radius of a circle, an area of which is equal to an area of a region surrounded with an outline of a projected coil body, the projected coil body provided by projecting the coil body on a projection plane perpendicular to the axial direction of the coil body.

Alternatively, each unit coil may include a wire coated with an insulation film, and the wires of the unit coils may be bundled and mutually winded along with the ring shape of the coil case so that the coil body is provided. Further, the number of the unit coils may be two, and a pair of two wires of the unit coils may be mutually winded.

Alternatively, the coil accommodation space may be provided by a groove in the coil case. The groove has an opening, which is disposed on one side in the axial direction of the coil case. The coil body is accommodated in the coil accommodation space. The coil body is prepared as a coreless coil so that the coil body is inserted into the coil accommodation space through the opening of the coil accommodation space. In this case, the manufacturing method of the antenna coil is simplified.

Alternatively, the coil case may include a pair of antenna terminals. Each unit coil includes a pair of lead portions. One of the lead portions in each unit coil having a same polarity is mutually connected to one of the antenna terminals. The other one of the lead portions in each unit coil having another same polarity is mutually connected to the other one of the antenna terminals. The polarity of the one of the lead portions is opposite to the polarity of the other one of the lead portions.

Alternatively, the coil case may include a plurality of pairs of antenna terminals, which correspond to the unit coils, respectively. Each unit coil includes a pair of lead portions. One of the lead portions in each unit coil is connected to one of a corresponding pair of the antenna terminals. The other one of the lead portions in each unit coil is connected to the other one of the corresponding pair of the antenna terminals.

According to a second aspect of the present disclosure, a resonant antenna includes: an antenna coil defined in the above first aspect of the present disclosure; and a resonant capacitor connecting in parallel to the antenna coil. The unit coils in the antenna coil provide a capacitance between wirings of the unit coils. The resonant capacitor has a capacitance. The capacitance of the unit coils is larger than the capacitance of the resonant capacitor.

The inductance of the antenna coil and the capacitance of the resonant capacitor are determined such that a resonant point is set to be in a predetermined frequency range. However, if one of the unit coils is broken, the broken unit coil is coupled with the not-broken unit coils through the capacitance between the wirings of the unit coils so that a parasitic series resonant circuit is provided between a capacitance between wirings of the unit coils and the broken unit coil. When the resonant point of the parasitic series resonant circuit is disposed near the designed antenna resonant point, the sensitivity of the antenna may be reduced. Even in this case, in the above resonant antenna, the resonant point of the parasitic series resonant circuit is set to be sufficiently lower frequency side; and therefore, the antenna sensitivity of the resonant antenna is prevented from reducing.

Alternatively, the capacitance of the unit coils may be equal to or more than five times as large as the capacitance of the resonant capacitor. In this case, even if one of the unit coils is broken, the antenna resonant point is not substantially shifted from the designed point. Here, the coupling capacitance between the unit coils is increased when the thickness of the insulation film between the unit coils becomes smaller. However, if the thickness of the insulation film becomes excessively small, short-circuit between the unit coils may be occurred. Thus, in view of this point, it is preferred that the capacitance of the unit coils is equal to or less than fifty times as large as the capacitance of the resonant capacitor.

Alternatively, the number of the unit coils may be two. Each unit coil includes a wire coated with an insulation film. A pair of two wires of the unit coils is mutually winded along with the ring shape of the coil case so that the coil body is provided. In this case, even if one of the unit coils is broken, the shift of the antenna resonant point is effectively reduced. Alternatively, the number of the unit coils may be equal to or more than 3. The number of turns is required to be a predetermined number so that the number of turns is constant even if the number of the unit coils becomes larger. To reduce the dimensions of the antenna coil in a case where the number of the unit coils becomes large, a pair of the wirings of the unit coils is mutually winded.

According to a third aspect of the present disclosure, a card type wireless device includes: a communication module substrate having a resonant antenna and a transmitting/receiving circuit; and a card type casing for accommodating the communication module substrate in such a manner that a thickness direction of the card type casing coincides with a thickness direction of the communication module substrate. The resonant antenna includes an antenna coil defined in the first aspect of the present disclosure and a resonant capacitor connecting in parallel to the antenna coil. The transmitting/receiving circuit connects to the resonant antenna. The coil body in the antenna coil has an axis, which coincides with a normal line of the communication module substrate. The coil body is bonded to the communication module substrate with solder.

The above wireless device is thin. Therefore, it is preferable to put the card type wireless device into a wallet or the like. Further, even when a coin in the wallet overlaps a principal surface of the card type wireless device, the antenna coil has sufficient area so that the coin does not interrupt the antenna coil completely. Thus, the card type wireless device has high sensitivity.

Alternatively, the card type wireless device may be a wireless key for an automotive vehicle. The wireless key is capable of transmitting a communication signal to the automotive vehicle with an electromagnetic wave. The communication signal includes an ID authentication signal and a control signal. The control signal corresponds to an unlock/lock function of a door of the automotive vehicle and an engine start function. The communication module substrate further includes a transponder circuit. The transponder circuit generates an electromagnetic wave corresponding to the communication signal in accordance with a request signal outputted from the automotive vehicle. The transponder circuit outputs the electromagnetic wave to the automotive vehicle through the resonant antenna, and/or receives the request signal from the automotive vehicle through the resonant antenna. The transmitting/receiving circuit has a power source of a battery. The transmitting/receiving circuit transmits an electromagnetic wave to the automotive vehicle through the resonant antenna, and/or receives an electromagnetic wave from the automotive vehicle through the resonant antenna.

In the above case, even if the battery runs out of power, the transponder circuit can generate the electromagnetic wave for outputting to the vehicle. Further, even of one of the unit coils in the antenna coil is broken, another one of the unit coils functions as a backup coil so that sufficient antenna function is maintained. Thus, a fail safe function of the wireless device is increased.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. An antenna coil comprising:
an air-core type flat coil body having a ring shape; and
a coil case having a ring shape corresponding to the ring shape of the coil body, wherein
the coil case includes a coil accommodation space for accommodating the coil body,
the coil accommodation space is disposed in a circumferential direction of the ring shape of the coil case,
the coil body includes a plurality of unit coils, each of which has a same winding direction and a same number of turns, and
the unit coils are connected in parallel each other.

2. The antenna coil according to claim 1, wherein
the coil body has a thickness in an axial direction of the coil body, and
the thickness of the coil body is smaller than a radius of a circle, an area of which is equal to an area of a region surrounded with an outline of a projected coil body, the projected coil body provided by projecting the coil body on a projection plane perpendicular to the axial direction of the coil body.

3. The antenna coil according to claim 1, wherein
each unit coil includes a wire coated with an insulation film, and
the wires of the unit coils are bundled and mutually winded along with the ring shape of the coil case so that the coil body is provided.

4. The antenna coil according to claim 3, wherein
the number of the unit coils is two, and
a pair of two wires of the unit coils is mutually winded.

5. The antenna coil according to claim 1, wherein
the coil accommodation space is provided by a groove in the coil case,
the groove has an opening, which is disposed on one side in the axial direction of the coil case,
the coil body is accommodated in the coil accommodation space, and
the coil body is prepared as a coreless coil so that the coil body is inserted into the coil accommodation space through the opening of the coil accommodation space.

6. The antenna coil according to claim 1, wherein
the coil case includes a pair of antenna terminals,
each unit coil includes a pair of lead portions,
one of the lead portions in each unit coil having a same polarity is mutually connected to one of the antenna terminals,
the other one of the lead portions in each unit coil having another same polarity is mutually connected to the other one of the antenna terminals, and
the polarity of the one of the lead portions is opposite to the polarity of the other one of the lead portions.

7. The antenna coil according to claim 1, wherein
the coil case includes a plurality of pairs of antenna terminals, which correspond to the unit coils, respectively,
each unit coil includes a pair of lead portions,
one of the lead portions in each unit coil is connected to one of a corresponding pair of the antenna terminals, and
the other one of the lead portions in each unit coil is connected to the other one of the corresponding pair of the antenna terminals.

8. A resonant antenna comprising:
an antenna coil defined in claim 1; and
a resonant capacitor connecting in parallel to the antenna coil, wherein
the unit coils in the antenna coil provide a capacitance between wirings of the unit coils,
the resonant capacitor has a capacitance, and
the capacitance of the unit coils is larger than the capacitance of the resonant capacitor.

9. The resonant antenna according to claim 8, wherein
the capacitance of the unit coils is equal to or more than five times as large as the capacitance of the resonant capacitor.

10. The resonant antenna according to claim 8, wherein
the number of the unit coils is two,
each unit coil includes a wire coated with an insulation film, and
a pair of two wires of the unit coils is mutually winded along with the ring shape of the coil case so that the coil body is provided.

11. A card type wireless device comprising:
a communication module substrate having a resonant antenna and a transmitting/receiving circuit; and
a card type casing for accommodating the communication module substrate in such a manner that a thickness direction of the card type casing coincides with a thickness direction of the communication module substrate, wherein
the resonant antenna includes an antenna coil defined in claim 1 and a resonant capacitor connecting in parallel to the antenna coil,
the transmitting/receiving circuit connects to the resonant antenna,
the coil body in the antenna coil has an axis, which coincides with a normal line of the communication module substrate, and
the coil body is bonded to the communication module substrate with solder.

12. The card type wireless device according to claim 11, wherein
the card type wireless device is a wireless key for an automotive vehicle,
the wireless key is capable of transmitting a communication signal to the automotive vehicle with an electromagnetic wave,
the communication signal includes an ID authentication signal and a control signal,
the control signal corresponds to an unlock/lock function of a door of the automotive vehicle and an engine start function,
the communication module substrate further includes a transponder circuit,
the transponder circuit generates an electromagnetic wave corresponding to the communication signal in accordance with a request signal outputted from the automotive vehicle,
the transponder circuit outputs the electromagnetic wave to the automotive vehicle through the resonant antenna, and/or receives the request signal from the automotive vehicle through the resonant antenna,
the transmitting/receiving circuit has a power source of a battery, and
the transmitting/receiving circuit transmits an electromagnetic wave to the automotive vehicle through the resonant antenna, and/or receives an electromagnetic wave from the automotive vehicle through the resonant antenna.
